(19) United States
(12) Patent Application Publication
(10) Pub. No.: US 2009/0283648 A1
(43) Pub. Date: Nov. 19, 2009

(54) Front-wheel steering gear having function of outputting directional signals

(75) Inventors: Tzu-Peng Chiang, Taichung City (TW); Wei-Long Chen, Taichung City (TW); Chia-Chang Chang, Taichung City (TW)

Correspondence Address: CHARLES E. BAXLEY, ESQUIRE, 90 JOHN STREET, SUITE 309, NEW YORK, NY, 10038, US

(73) Assignee: Cycling & Health Tech Industry Research & development Center

(21) Appl. No.: 12/152,694

(22) Filed: May 15, 2008

(51) Int. Cl. F16M 11/08

(52) U.S. Cl. 248/187.1

(57) ABSTRACT

A front-wheel steering gear having a function of outputting a directional signal, comprises a turntable assembly, which has a stationary base, a turntable rotatably mounted on the stationary base and a front-wheel positioning rack fixedly attached to a top surface of the turntable; an axially extendable rail, having one end thereof connected to the stationary base of the turntable assembly; a rear-wheel positioning rack, connected to another end of the rail; and a steering sensor, provided on the turntable assembly for detecting rotational directions and angles of the turntable and outputting signals corresponding to the rotational directions and angles to an interactive device.

### BACKGROUND OF THE INVENTION

1. Technical Field

The present invention relates to bicycles. More particularly, the present invention enables a conventional bicycle to act as an interface interactively communicated with a multimedia device and in turn function as a controller of the multimedia device without a need of any significant modification of the bicycle.

2. Description of Related Art

Stationary bicycles have been popular for fitness purpose in recent years. A typical stationary bicycle, which comprises a pair of handles and a damper and is of a mono wheel type, is mounted on a foundation so that the foundation props up the wheel of the bicycle from the ground by a predetermined distance and holds the bicycle in a balance state, wherein the damper is connected to the bicycle for providing a resistance for simulating a resistance happening in a real bicycle-ride.

While most discontents about the conventional stationary bicycles are directed to the boring operation that tends to incur users' weary feeling, it is the main solution to add interest to the operation of the conventional bicycles. One approach is to provide a simulative bicycle-riding course or a game situation to the riders through a display device, such as a television, a computer monitor, a pair of virtual reality gaming glasses, or something the like. Such approach allows a rider of the stationary bicycle to interact with the simulative bicycle-riding course or the game situation by steering the handles and controlling the riding speed. Some virtual reality system can even provide a feedback control function by changing the resistance to the wheel of the stationary bicycle or altering the inclination angle of the stationary bicycle according to a road status of the simulative bicycle-riding course.

To enjoy such interesting exercise, it is necessary to purchase a said stationary bicycle. However, not only is the conventional stationary bicycle expensive for a family but also it is incapable of fitting all members in the family due to its fixed model and size. Besides, while virtual reality system is also a suitable tool to train a bicycle racer by proving various simulative ride courses instead of an insite training, it is preferred that the racer can use the bicycle his/her usually rides for training. Thus, it would be an ultimate solution to provide a platform allowing a common bicycle or a race bicycle (hereinafter both referred to as the “bicycle”) to be interactively communicated with a multimedia device so as to meet both entertainment and training needs.

### SUMMARY OF THE INVENTION

One objective of the present invention is to provide a front-wheel steering gear, which is communicated with a multimedia device such as a computer or a video game system so that the steering gear rapidly and easily integrates a bicycle with the multimedia device without a need of physical modification of the bicycle.

Another objective of the present invention is to provide a front-wheel steering gear, which is substantially a modulized device for being installed on another modulized assembly, wherein the modulized assembly may be a functional device or a seat for receiving and positioning the steering gear at a particular position.

Another objective of the present invention is to provide a front-wheel steering gear, which can work with a rear wheel stand of any type to corporately support a bicycle.

Another objective of the present invention is to provide a front-wheel steering gear, which allows a front wheel of a bicycle to be inlaid thereon so that the steering gear can be controlled by a pair of handles through the front wheel of the bicycle and detects a steering angle of the front wheel so as to output a directional signal to a multimedia device, thereby interactively communicating the front wheel of the bicycle and the multimedia device.

To achieve the foregoing objectives of the present invention, the disclosed front-wheel steering gear comprises a turntable assembly, which has a stationary base, a turntable rotatably mounted on the stationary base, and a front-wheel positioning rack fixedly attached to a top surface of the turntable; an axially extendable rail, having one end thereof connected to the stationary base of the turntable assembly; a rear-wheel positioning rack, connected to another end of the rail; and a steering sensor, provided on the turntable assembly for detecting a rotational direction and a rotational angle of the turntable and outputting signals corresponding to the rotational directions and rotational angles to an interactive device.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is an oblique top elevation of a steering gear of the present invention;

FIG. 2 is an oblique bottom elevation of the steering gear of the present invention;

FIG. 3 is an exploded view of the steering gear of the present invention;

FIG. 4 is a cross-sectional view taken in an enlarged scale along line 4-4 of FIG. 1;

FIG. 5 is a schematic sectional view showing the steering gear assembled with a bicycle and a rear-wheel stand;

FIG. 6 is a schematic sectional view showing a turntable of the steering gear at an first position; and

FIG. 7 is a schematic sectional view showing the turntable of the steering gear rotated for a predetermined angle and set at a second position.

### DETAILED DESCRIPTION OF THE PREFERRED EMBODIMENT

While a preferred embodiment is provided herein for illustrating the concept of the present invention as described above, it is to be understood that the components in these drawings are made for better explanation and need not to be made in scale.

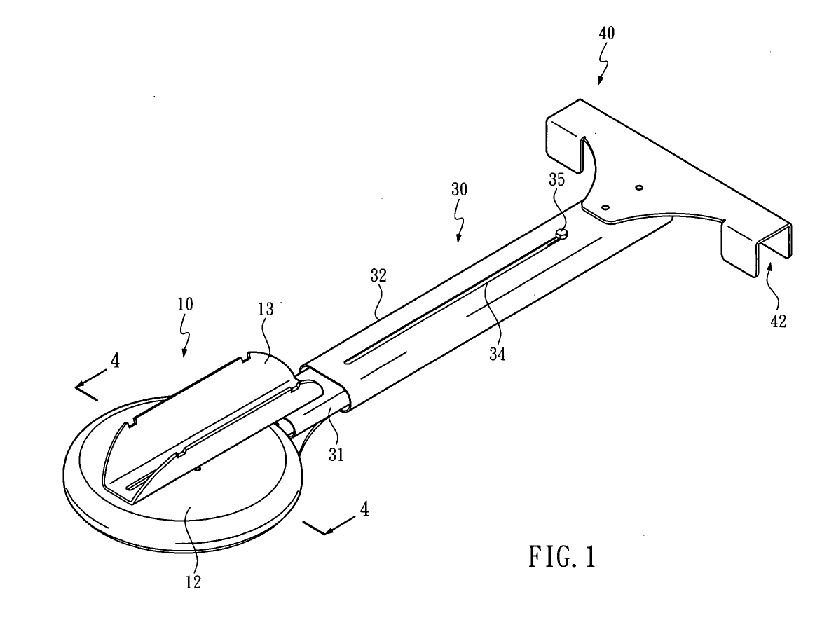

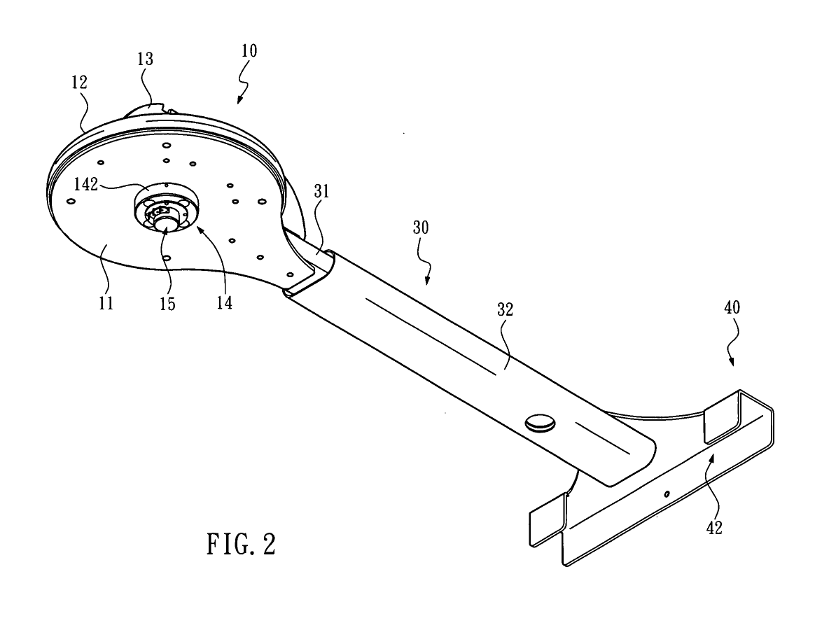

FIGS. 1 and 2 are oblique elevations of a steering gear of the present invention. The front-wheel steering gear comprises a turntable assembly 10, a rail 30 connected to the turntable assembly 10, and a rear-wheel positioning rack 40 connected to the rail 30.

The turntable assembly 10 includes a stationary base 11 a turntable 12. The turntable 12 is rotatably mounted on the stationary base 11 and a front-wheel positioning rack 13 fixedly attached to a top surface of the turntable 12.

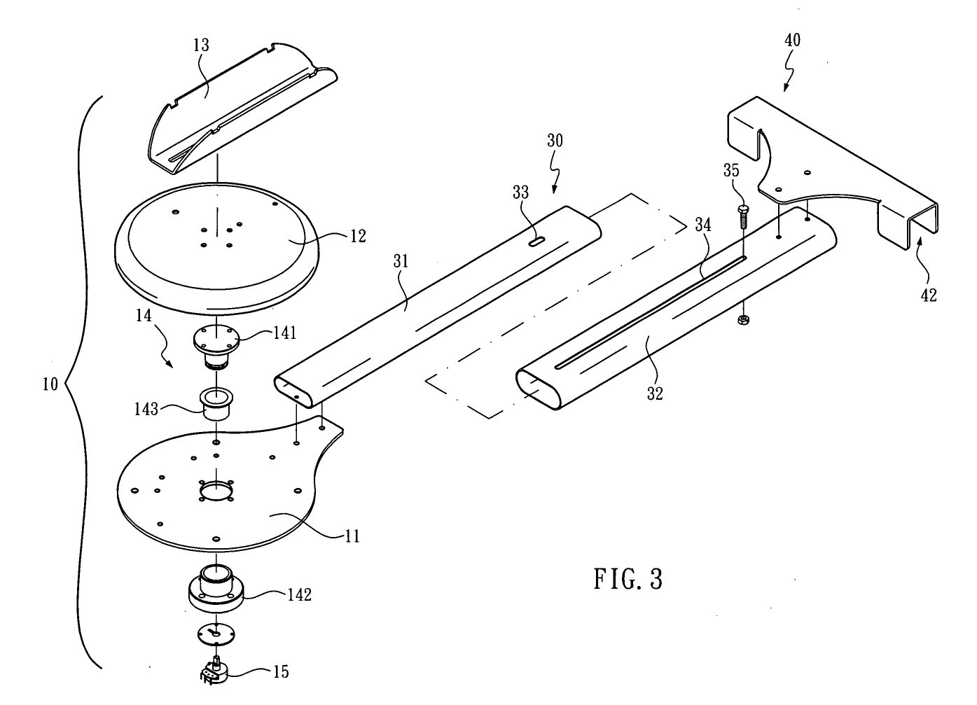

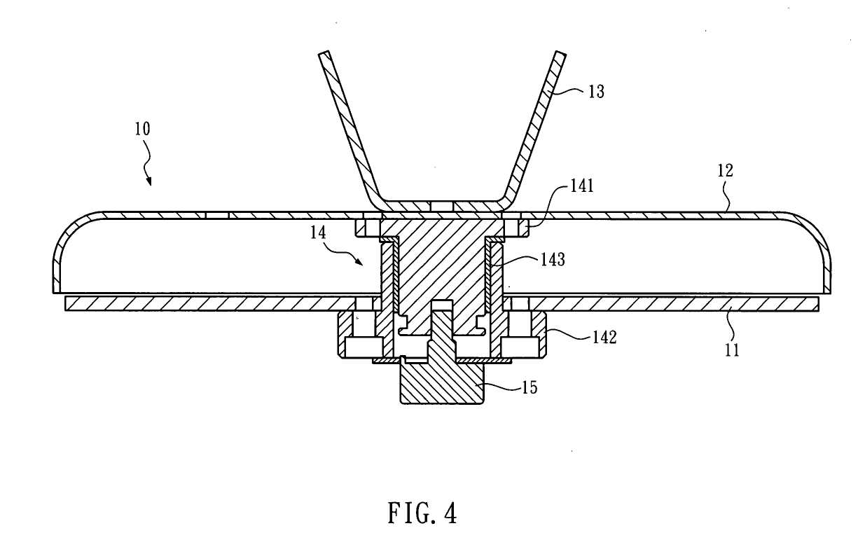

FIG. 3 is an exploded view of the steering gear of the present invention. Therein, the stationary base 11 of the turntable assembly 10 is equipped with a rotation assembly 14 for supporting the turntable 12 mounted thereon. The rotation assembly 14 includes, but is not limited to, a component or an assembly mainly constructed of a bearing. From the drawing, the rotation assembly 14 comprises an upper bearing seat 141 fixedly attached to a bottom surface of the turntable 12, a lower bearing seat 142 fixedly attached to the stationary base, and an oilless bearing 143 settled between the upper bearing seat 141 and the lower bearing seat 142, wherein the upper bearing seat 141 rotates with the turntable 12. A steering sensor 15 detects a rotational direction and a rotational angle of the turntable 12 and outputs signals corresponding to the rotational direction and angle to an interactive device (not shown). The steering sensor used herein may be any component or assembly serving to detect the rotational direction and the rotational angle of the turntable. As shown in FIGS. 3 and 4, the steering sensor is a rotary variable resistor settled in the lower bearing seat 142 for sensing a rotation of the upper bearing seat 141. Alternative, the steering sensor 15 may be a G-Sensor provided inside the turntable.

FIG. 3 also illustrates the rail 30 connected to the turntable assembly 10 and the rear-wheel positioning rack 40. The rail 30 includes a fixed rod 31 and a movable sleeve 32 wherein the fixed rod 31 and the movable sleeve 32 are axially telescoped. The fixed rod 31 has one end thereof fixedly attached to the stationary base 11 of the turntable assembly 10 and the movable sleeve 32 has one end thereof relatively far from the turntable assembly 10 fixedly attached to the rear-wheel positioning rack 40. The fixed rod 31 and the movable sleeve 32 are such assembled that a fixing hole 33 and a slot 34 thereof are positionally corresponding to each other so that a positioning component 35 can pass through the fixing hole 33 and the slot 34 to combine the fixed rod 31 and the movable sleeve 32 in a manner that the movable sleeve 32 is allowed to move along the fixed rod 31 so as to change an axial length of the rail 30.

The rear-wheel positioning rack 40 shown in FIG. 3 is of a universal structure that can be combined with a real-wheel stand 41 of any type because the structure of the rear-wheel positioning rack 40 can be modified to match the real-wheel stand 41.

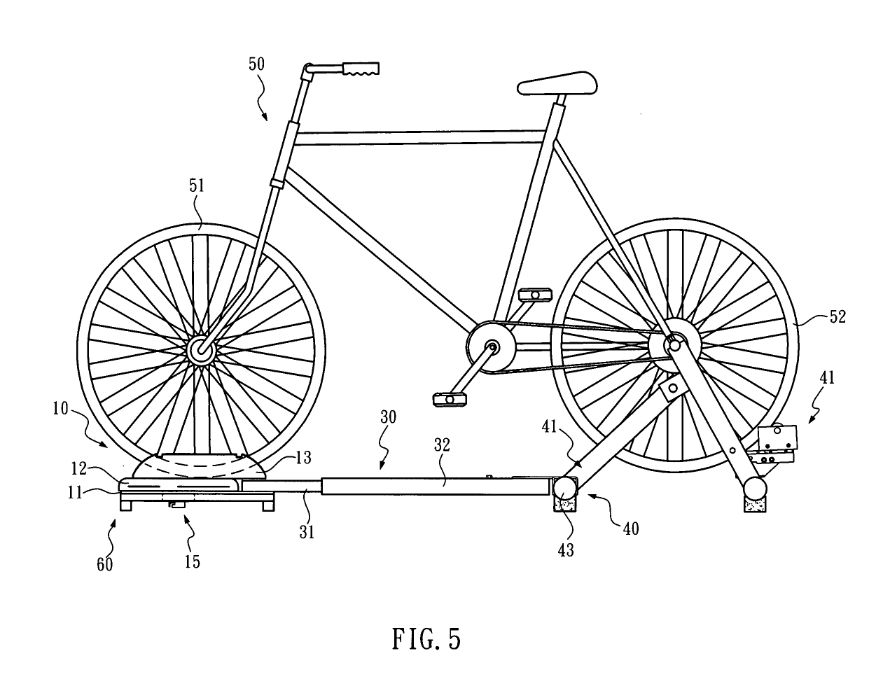

FIG. 5 is a lateral view of the disclosed steering gear assembled with a bicycle 50 and the real-wheel stand 41. Therein, the turntable assembly 10 is installed on a modulized assembly 60. The modulized assembly 60 may be a functional device or a seat for receiving and positioning the turntable assembly 10 at a particular position, as shown in FIG. 5. The bicycle 50 has a front wheel 51 inlaid in the front-wheel positioning rack 13 and a rear wheel 52 propped from the ground by the real-wheel stand 41. The rear-wheel positioning rack 40 includes an inner positioning space 42 for receiving a bottom rod 43 of the real-wheel stand 41 so that the real-wheel stand 41 and the rear-wheel positioning rack 40 are combined and positioned with respect to each other. The rail 30 can be extended or retracted so as to make the length thereof match dimensions of the bicycle and ensure that the front wheel 51 and the rear wheel 52 are properly fixed by the front-wheel positioning rack 13 and the real-wheel stand 41.

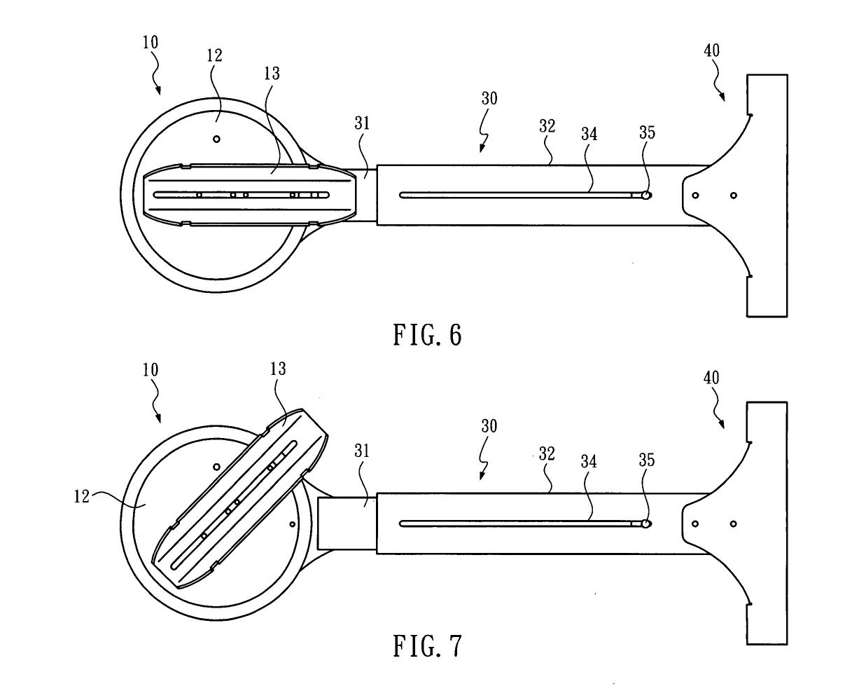

FIGS. 6 and 7 are top views of the steering gear controlled by the bicycle. Therein, for clearly presenting states of the steering gear, the bicycle is omitted from the drawings. When a head tube of the bicycle 50 is rotated, a corresponding rotational direction and a corresponding rotational angle of the front wheel 51 are reflected at the turntable 12. Then the steering sensor 15 detects the rotational direction and the rotational angle of the turntable 12 in order to output signals corresponding to the rotational direction and the rotational angle. The signals are afterward converted by a particular circuitry or a program to be further transmitted to an interactive device in a wire or wireless manner. The interactive device receives and processes the signals and presents the same in an interactive software pertaining to the interactive device. Thereby, the front wheel of the bicycle is in communication with the multimedia device and a rider of the bicycle can operate the bicycle 50 in response to the situational scene provided by the interactive software.

Although the particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A front-wheel steering gear having a function of outputting a directional signal, comprising:
a turntable assembly, which has a stationary base, a turntable rotatably mounted on the stationary base, and a front-wheel positioning rack fixedly attached to a top surface of the turntable;
an axially extendable rail, having one end thereof connected to the stationary base of the turntable assembly;
a rear-wheel positioning rack, connected to another end of the rail opposite to the end connected to the turntable assembly; and
a steering sensor, provided on the turntable assembly for detecting a rotational direction and a rotational angle of the turntable and outputting the directional signals corresponding to the rotational direction and the rotational angle to an interactive device.

2. The front-wheel steering gear of claim 1, wherein the stationary base is equipped with a rotation assembly for supporting the turntable.

3. The front-wheel steering gear of claim 2, wherein the rotation assembly is an assembly mainly constructed of a bearing.

4. The front-wheel steering gear of claim 3, wherein the rotation assembly comprises an upper bearing seat fixedly attached to a bottom surface of the turntable, a lower bearing seat fixedly attached to the stationary base, and an oilless bearing settled between the upper bearing seat and the lower bearing seat.

5. The front-wheel steering gear of claim 4, wherein the steering sensor is a rotary variable resistor settled in the lower bearing seat for sensing a rotation of the upper bearing seat.

6. The front-wheel steering gear of claim 1, wherein the steering sensor is a G-Sensor (Gravity Sensor) built inside the turntable.

7. The front-wheel steering gear of claim 1, wherein the rail includes a fixed rod and a movable sleeve axially telescoped, in which the fixed rod has one end thereof fixedly attached to the stationary base of the turntable assembly and the movable sleeve has one end opposite to the end adjacent to the turntable assembly fixedly attached to the rear-wheel positioning rack.

8. The front-wheel steering gear of claim 7, wherein the fixed rod and the movable sleeve are such assembled that a fixing hole and a slot thereof are positionally corresponding to each other so that a positioning component passes through the fixing hole and the slot to combine the fixed rod and the movable sleeve.

9. The front-wheel steering gear of claim 1, being installed on a modulized assembly.

10. The front-wheel steering gear of claim 9, wherein the modulized assembly is a seat for receiving and positioning the front-wheel steering gear at a particular position.
